(19) United States
(12) Patent Application Publication
(10) Pub. No.: US 2013/0055845 A1
(43) Pub. Date: Mar. 7, 2013

(54) ROTATIONALLY SUPPORTED STEERING SPINDLE

(71) Applicant: Manfred Rombold, Winnenden-Hofen (DE)

(72) Inventor: Manfred Rombold, Winnenden-Hofen (DE)

(73) Assignee: ThyssenKrupp Presta AG, Eschen (LI)

(21) Appl. No.: 13/697,606

(22) PCT Filed: May 25, 2011
(86) PCT No.: PCT/EP2011/002597

§ 371 Date: Nov. 13, 2012

(30) Foreign Application Priority Data
Jun. 23, 2010 (DE) 1020100248479

(51) Int. Cl. B62D 1/181

(52) U.S. Cl. 74/493

(57) ABSTRACT

The invention relates to a steering actuator for a motor vehicle having a steering spindle displaceably mounted in a longitudinal direction in a steering housing, the steering spindle carrying a piston in a non-rotatable and non-displaceable manner, which is arranged so as to be displaceable with the steering spindle in a section of the steering housing designed as a cylinder and which delimits at least one hydraulic working chamber, the piston and the cylinder being of non-round design in a plane orientated perpendicular to the longitudinal direction.

The invention relates to an actuator for a motor vehicle steering system having the features of the preamble of claim 1.

In motor vehicle steering systems with the general construction type of a rack-and-pinion steering system, a steering rack or steering spindle is mounted in a steering housing in a longitudinally displaceable manner. The displacement in the longitudinal direction effects a swivelling of the steered wheels of the motor vehicle via tie rods and steering knuckles connected to the steering rack. The steering rack is normally actuated by a steering shaft via a tooth engagement. The tooth engagement, in which a steering pinion meshes with a toothed segment of the steering rack, also simultaneously prevents a rotation of the steering rack about its longitudinal axis. The pinion thereby supports the steering rack against a rotational movement.

Torques, which can effect the rotational movement of the steering rack, are, on the one hand, introduced into the steering rack via tie rods. On the other hand, there exist rack-and-pinion steering systems actuated or assisted electromechanically in which a gear mechanism is provided to convert a rotatory drive movement into a linear movement of the steering rack. The gear mechanism can, for example, comprise a recirculating ball system, which coaxially surrounds the steering rack and interacts with a ball thread on the steering rack. The recirculating ball system is actuated via a hollow shaft motor or via an electric motor arranged laterally alongside the recirculating ball system and via a gear mechanism. A rotation of the recirculating ball system effects a longitudinal displacement of the steering rack or steering spindle. The torque associated therewith is supported as described above.

For various reasons, for certain applications effort is made to avoid the steering shaft, in other words the substantially torsionally rigid connection between a steering wheel and a steering pinion. This can be advantageous for accident safety reasons, but also in order to avoid structure-borne sound transmission between the forward axis and the inner space of the motor vehicle. For such cases steering gears were developed, in which a mechanical coupling between the steering wheel and the steering gear, for example, via wire rope hoists or via hydraulic master and slave units are provided [sic]. Such steering systems can be configured with or without servo assistance. Steer-by-wire steering systems are also known, which provide a pure electrical coupling between the steering wheel and the steering gear.

If the normal torque support in the region of the pinion is excluded, it is necessary to support the torque produced by road reactions or also by a servo drive by another means. This applies in particular for electrically assisted steering systems with the recirculating ball system mentioned or another rotatory gear mechanism.

In this connection, it is the object of the present invention to provide a support for the steering spindle in a steering actuator with a hydraulic working cylinder which permits a particularly compact manner of construction. This object is achieved by a steering actuator having the features of claim 1.

Since the steering actuator has a non-circular, in particular, non-round hydraulic piston, the steering spindle can be supported via the piston on the steering housing which is likewise non-circular. The rotation generated by the occurrence of a torque about the longitudinal axis is thereby reliably prevented.

Preferably the steering spindle as a gear member is part of a gear mechanism, which converts a rotatory movement of an electric servo motor into a linear movement of the steering spindle, such as for example an epicycle gearing, a spindle drive, or the like. In particular the steering spindle is preferably provided with a ball thread, which a recirculating ball gear uses for the electromotive drive of the steering spindle.

It is further preferable for the piston to be designed in the form of a regular polygon. A further preferred embodiment makes provision for the piston to be provided on its outer circumference with a sealing insert and a separate sliding insert, which abut on the inside of the steering housing.

In the context of the present patent application “steering spindle” is to be understood to mean a rod-like gear member displaceably supported within the steering housing, which corresponds to a steering rack in function, but does not necessarily comprise a corresponding toothing. The word “cylindrical” is to be understood in the mathematical sense and indicates a shape with two congruent base areas, which are connected to each other via a lateral surface. The term “non-round” means in the case of this definition that the base areas are not circles.

An exemplary embodiment of the present invention will be described in more detail below using the drawings, in which

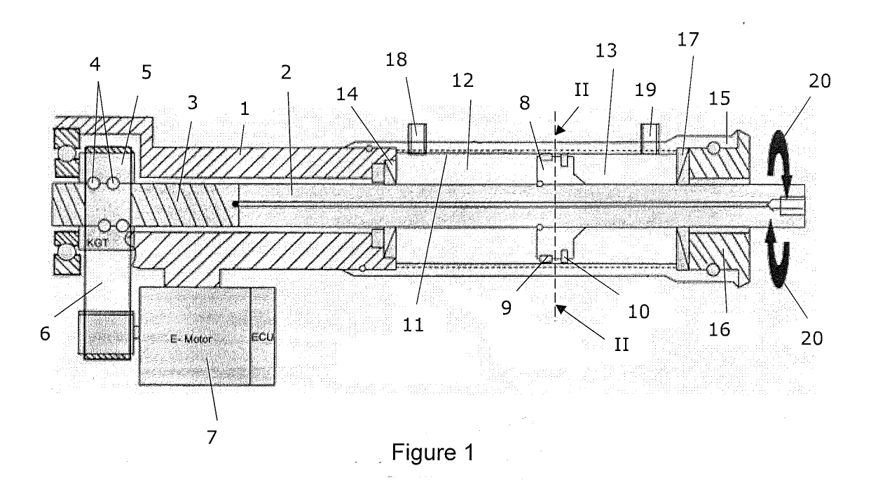

FIG. 1: shows a steering actuator according to the invention in a longitudinal profile; and

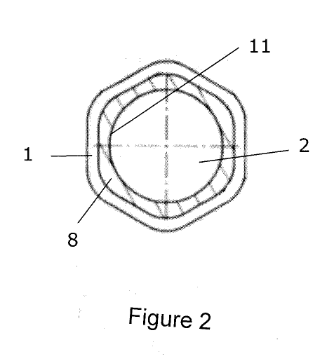

FIG. 2: shows the actuator from FIG. 1 in a cross section along the line II-II.

A steering actuator for a motor vehicle is illustrated in FIG. 1 in a longitudinal profile. The steering actuator comprises a steering housing 1, in which a steering spindle 2 is arranged in a longitudinally displaceable manner. The steering spindle 2 is provided with a ball thread 3, which together with balls 4 and a ball nut 5 forms a ball screw. The ball screw is actuated in this exemplary embodiment via a toothed belt 6 of an electric motor 7. In a known manner, a rotation of the ball nut 5 effects a linear displacement of the steering spindle 2 in the longitudinal direction.

The steering spindle 2 further comprises a piston 8. The piston 8 is provided with a sealing insert 9 and a sliding insert 10 and sits approximately concentrically on the steering spindle 2. The steering housing 1 comprises a cylindrical inner surface 11, on which the piston 8 abuts with the sealing insert 9 and the sliding insert 10. During a longitudinal movement of the steering spindle 2, the piston 8 slides on the surface 11 in the longitudinal direction.

The inner surface 11 of the steering housing 1 delimits an inner space, which is subdivided by the piston 2 into a first working chamber 12 and a second working chamber 13. The first working chamber 12 is hydraulically sealed off by means of sealing ring 14 from the section of the steering housing 1, in which the ball screw is arranged. On the opposite end, the steering housing 1 has a free end 15, in which the steering spindle 2 is supported in a sliding bearing 16. The second working chamber 13 is sealed off from the sliding bearing 16 in a sealing ring 17. Thus with the piston 8 and the two working chambers 12, 13, the steering spindle 2 forms a doubly effective piston-cylinder unit. Hydraulic connections 18 and 19 are provided for connecting the working chamber 12 and 13 with a hydraulic system known per se.

The steering actuator does not have a steering pinion. The steering actuator according to this exemplary embodiment is rather provided for a steering system in which a steering wheel is connected to a hydraulic piston-cylinder unit via a short steering column as the master unit. The master unit is connected via hydraulic lines to the connections 18, 19 of the steering actuator. The two working chambers 12 and 13 are subsequently both connected to the piston 8 as the slave unit which effects a displacement of the steering spindle 2 in the longitudinal direction when the steering wheel, not shown, rotates and namely, in a simple embodiment without hydraulic steering support. Such a hydraulic system is “hydraulically rigid” due to the exclusion of a hydraulic pump and can as such be designed as a simple steer-by-wire system, which does not require any complex sensor systems or complete redundancy.

The power-assisted steering is applied, in the case it is necessary, by the electric motor 7 via the ball screw on the steering spindle 2. In this case, torques are generated about the longitudinal axis in the direction of the torque arrow 20. In order to support these torques, the piston 8 is of non-round design, as is illustrated in FIG. 2.

FIG. 2 shows a cross section along the line II/II through the steering actuator from FIG. 1. The piston 8 is substantially hexagonally designed with rounded corners and is supported in the circumferential direction in the correspondingly designed steering housing 1, the sealing insert 9 and the sliding insert 10 not being shown. The steering spindle 2 is round in a known manner and of rod-like design.

The actuator described and schematically illustrated in this respect can be configured in a particularly short manner in its longitudinal direction because the torque support takes places in the region of the unrounded piston. No guides or supports aside from the ball thread 3 or the hydraulic slave unit are required. Such supports would otherwise be provided for example in the region of the bearing bush 16 and would require additional construction space there. This is avoided with the solution illustrated.

The support of the steering spindle against torque by means of the unrounded hydraulic piston can also be provided in other similar steering gears, which comprise a purely mechanical connection between the steering column and the steering spindle via a steering pinion or the like. The embodiment of the mechanical connection can then be designed more simply and thus more readily and more economically because this assembly does not also have to support the torque in addition to the power transmission.

Preferred forms of the hydraulic piston in the technical sense are non-round. In technology, geometric shapes and cross sections, which periodically deviate from the circle or a circular movement, are designated as non-round. The piston can in particular have the shape of a so-called curve of constant width.

### REFERENCE NUMERALS

1. Steering housing
2. Steering spindle
3. Ball thread
4. Balls
5. Ball nut
6. Toothed belt
7. Electric motor
8. Piston
9. Sealing insert
10. Sliding insert
11. Cylindrical inner surface
12. Working chamber
13. Working chamber
14. Sealing ring
15. Free end
16. Sliding bearing
17. Sealing ring
18. Hydraulic connection
19. Hydraulic connection
20. Torque arrow

1. Steering A steering actuator for a motor vehicle, comprising: a steering housing; a steering spindle displaceably mounted in a longitudinal direction in the steering housing, which steering spindle carries a piston in a non-rotatable and non-displaceable manner, which is arranged so as to be displaceable with the steering spindle in a section of the steering housing designed as a cylinder, and which delimits, together with the steering housing, at least one hydraulic working chamber,
wherein the piston and the cylinder are of non-circular design in a plane oriented orientated perpendicular to the longitudinal direction.

2. The steering actuator according to claim 1, wherein the piston and the cylinder are of non-round design in a plane oriented perpendicular to the longitudinal direction.

3. The steering actuator according to claim 1, wherein the steering spindle, as a gear member, is part of a gear mechanism, which converts a rotatory movement of an electric servo motor into a linear movement of the steering spindle.

4. The steering actuator according to claim 3, wherein the gear mechanism includes a ball screw, which coaxially surrounds the steering spindle and interacts with a ball thread arranged on the steering spindle.

5. The steering actuator according to claim 1, wherein the piston and the cylinder have a polygonal cross section with rounded corners perpendicular to the longitudinal direction.

6. The steering actuator claim 1, wherein the piston is designed in the form of a regular polygon.

7. The steering actuator claim 1, wherein the piston on its outer circumference is provided with a sealing insert and a separate sliding insert spaced from the sealing insert in the longitudinal direction, which abut on an inside portion of the steering housing.
